(19) United States
(12) Patent Application Publication
(10) Pub. No.: US 2006/0065288 A1
(43) Pub. Date: Mar. 30, 2006

(54) Supercritical fluid processing system having a coating on internal members and a method of using

(76) Inventors: Darko Babic, Chandler, AZ (US); Carl L. White, Gilbert, AZ (US); Alexei Sheydayi, Gilbert, AZ (US)

Correspondence Address: WOOD, HERRON & EVANS, LLP (TOKYO ELECTRON), 2700 CAREW TOWER, 441 VINE STREET, CINCINNATI, OH, 45202, US

(21) Appl. No.: 10/955,927

(22) Filed: Sep. 30, 2004

(51) Int. Cl. C23G 1/00; B08B 5/04; B08B 3/12

(52) U.S. Cl. 134/2; 134/21; 134/184

(57) ABSTRACT

A processing system utilizing a supercritical fluid for treating a substrate is described as having internal members having a coating. For example, the coating in internal members can reduce particulate contamination during processing. Additionally, a method for using the processing system is described.

### BACKGROUND OF THE INVENTION

This application is related to U.S. patent applications filed as Express Mail Nos.: EV536052737US and EV536052723US, all filed on even date herewith, hereby expressly incorporated by reference herein.

1. Field of the Invention

The present invention relates to coating internal members of a supercritical fluid processing system and a method for applying the coating and, more particularly, to internal members having a coating configured to reduce particulate or contamination in a supercritical fluid processing system and a method for applying such a coating to these internal members.

2. Description of Related Art

During the fabrication of semiconductor devices for integrated circuits (ICs), a critical processing requirement for processing semiconductor devices is cleanliness. The processing of semiconductor devices includes vacuum processing, such as etch and deposition processes whereby material is removed from or added to a substrate surface, as well as atmospheric processing, such as wet cleaning whereby contaminants or residue accumulated during processing are removed. For example, the removal of residue, such as photoresist (serving as a light-sensitive mask for etching), post-etch residue, and post-ash residue subsequent to the etching of features, such as trenches or vias, can utilize plasma ashing with an oxygen plasma followed by wet cleaning.

Other critical processing requirements for the processing of semiconductor devices include substrate throughput and reliability. Production processing of semiconductor devices in a semiconductor fabrication facility requires a large capital outlay for processing equipment. In order to recover these expenses and generate sufficient income from the fabrication facility, the processing equipment requires a specific substrate throughput and a reliable process in order to ensure the achievement of this throughput.

Until recently, plasma ashing and wet cleaning were found to be sufficient for removing residue and contaminants accumulated during semiconductor processing. However, recent advancements for ICs include a reduction in the critical dimension for etched features below a feature dimension acceptable for wet cleaning, such as a feature dimension below 45 to 65 nanometers, as well as the introduction of new materials, such as low dielectric constant (low-k) materials, which are susceptible to damage during plasma ashing.

Therefore, at present, interest has developed for the replacement of plasma ashing and wet cleaning. One interest includes the development of dry cleaning systems utilizing a supercritical fluid as a carrier for a solvent, or other residue removing composition. Post-etch and post-ash cleaning are examples of such systems. Other interests include other processes and applications that can benefit from the properties of supercritical fluids, particularly of substrates having features with a dimension of 65 nm, or 45 nm, or smaller. Such processes and applications may include restoring low dielectric films after etching, sealing porous films, drying of applied films, depositing materials, as well as other processes and applications. However, high pressure processing systems utilizing supercritical fluids must meet cleanliness requirements imposed by the semiconductor processing community. Additionally, high pressure processing systems must meet throughput requirements, as well as reliability requirements.

### SUMMARY OF THE INVENTION

One aspect of the present invention is to reduce or eliminate any or all of the above-described problems.

Another object of the present invention is to provide internal members having a coating for use in a supercritical fluid processing system.

Another object of the present invention is to provide a method of using coated internal members in a supercritical processing system.

According to one aspect, an internal member of a system for processing a substrate with a supercritical fluid, the member is described comprising: a structural element configured to be coupled to a high pressure processing system, a coating coupled to one or more surfaces of said structural element, and configured to reduce contamination released from the element into said supercritical fluid in said high pressure processing system.

According to another aspect, a high pressure processing system for treating a substrate with a supercritical fluid is described comprising: a processing chamber configured to treat said substrate with a high pressure fluid, introduced therein, having substantially supercritical fluid properties, a high pressure fluid supply system coupled to said processing chamber, and configured to introduce a high pressure fluid to said processing chamber, a process chemistry supply system coupled to said processing chamber, and configured to introduce a process chemistry to said processing chamber, a fluid flow system coupled to said processing chamber, and configured to circulate said high pressure fluid and said process chemistry through said processing chamber over said substrate; and a coating coupled to one or more surfaces of said processing chamber, said high pressure fluid supply system, said process chemistry supply system, or said recirculation system, or any combination thereof.

According to another aspect, a high pressure processing system for treating a substrate is described comprising: a processing chamber configured to treat said substrate with a high pressure fluid, introduced therein, having substantially supercritical fluid properties, a carbon dioxide supply system coupled to said processing chamber, and configured to introduce carbon dioxide to said processing chamber, a process chemistry supply system coupled to said processing chamber, and configured to introduce a process chemistry to said processing chamber, a fluid flow system coupled to said high pressure processing system, and configured to flow supercritical carbon dioxide and said process chemistry through said processing chamber over said substrate, and a coating coupled to one or more surfaces of said processing chamber, said carbon dioxide supply system, said process chemistry supply system, or said fluid flow system, or any combination thereof.

According to yet another aspect, a method for treating a substrate in a supercritical processing system is described comprising: disposing an internal member in the supercritical processing system having a coating on one or more surfaces configured to reduce contamination in the supercritical processing system, wherein the coating protects the internal member from process chemistry, supercritical fluid, or both in the supercritical processing system; disposing a substrate in the supercritical processing system; exposing the substrate to the supercritical fluid; and exposing the substrate to the processing chemistry.

### BRIEF DESCRIPTION OF THE DRAWINGS

In the accompanying drawings:

FIG. 1 presents a simplified schematic representation of a high pressure processing system in accordance with an embodiment of the invention;

FIG. 2 presents a simplified schematic representation of a high pressure processing system in accordance with another embodiment of the invention; and

FIG. 3 illustrates an exemplary method of operating a high pressure processing system.

### DETAILED DESCRIPTION OF EXEMPLARY EMBODIMENTS

In the following description, to facilitate a thorough understanding of the invention and for purposes of explanation and not limitation, specific details are set forth, such as a particular geometry of the high pressure processing system and various descriptions of the internal members. However, it should be understood that the invention may be practiced with other embodiments that depart from these specific details.

Nonetheless, it should be appreciated that, contained within the description are features which, notwithstanding the inventive nature of the general concepts being explained, are also of an inventive nature.

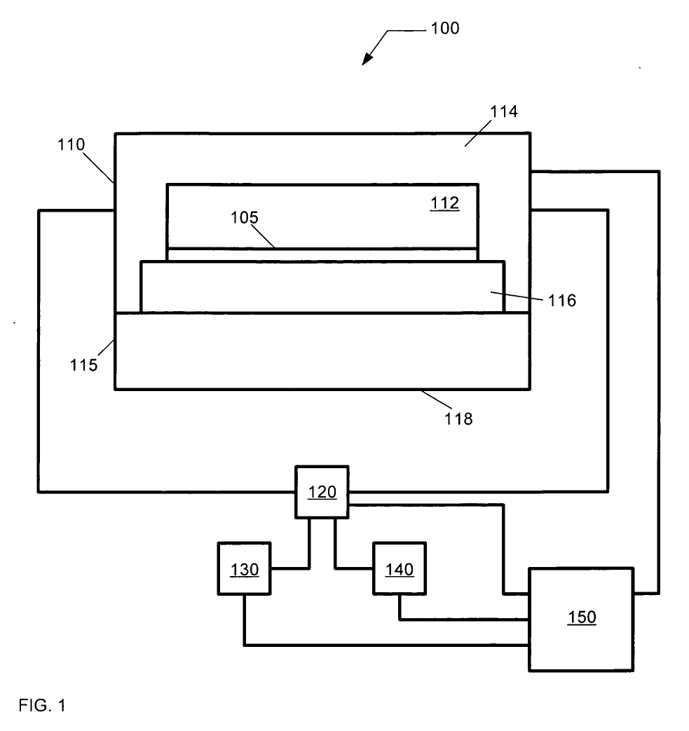

Referring now to the drawings, wherein like reference numerals designate identical or corresponding parts throughout the several views, FIG. 1 illustrates a high pressure processing system 100 according to an embodiment of the invention. In the illustrated embodiment, high pressure processing system 100 comprises processing elements that include a processing chamber 110, a fluid flow system 120, a pre-mixing system 160, a process chemistry supply system 130, a high pressure fluid supply system 140, and a controller 150, all of which are configured to process substrate 105. The controller 150 can be coupled to the processing chamber 110, the fluid flow system 120, the pre-mixing system 160, the process chemistry supply system 130, and the high pressure fluid supply system 140. Alternately, or in addition, controller 150 can be coupled to a one or more additional controllers/computers (not shown), and controller 150 can obtain setup and/or configuration information from an additional controller/computer.

In FIG. 1, singular processing elements (110, 120, 130, 140, and 150) are shown, but this is not required for the invention. The high pressure processing system 100 can comprise any number of processing elements having any number of controllers associated with them in addition to independent processing elements.

The controller 150 can be used to configure any number of processing elements (110, 120, 130, and 140), and the controller 150 can collect, provide, process, store, and display data from processing elements. The controller 150 can comprise a number of applications for controlling one or more of the processing elements. For example, controller 150 can include a graphic user interface (GUI) component (not shown) that can provide easy to use interfaces that enable a user to monitor and/or control one or more processing elements.

Referring still to FIG. 1, the fluid flow system 120 is configured to flow fluid and chemistry from the supplies 130 and 140 through the chamber 110. The fluid flow system 120 is illustrated as a recirculation system through which the fluid and chemistry recirculate from and back to the chamber 110. This recirculation is most likely to be the preferred configuration for many applications, but this is not necessary to the invention. Fluids, particularly inexpensive fluids, can be passed through the chamber once then discarded, which might be more efficient than reconditioning them for reentry into the chamber. Accordingly, while the fluid flow system is described as a recirculating system in the exemplary embodiments, a non-recirculating system may, in some cases, be substituted. This fluid flow system or recirculation system 120 can include one or more valves for regulating the flow of a processing solution through the recirculation system 120 and through the processing chamber 110. The recirculation system 120 can comprise any number of back-flow valves, filters, pumps, and/or heaters (not shown) for maintaining a specified temperature, pressure or both for the processing solution and flowing the process solution through the recirculation system 120 and through the processing chamber 110.

Referring still to FIG. 1, the high pressure processing system 100 can comprise high pressure fluid supply system 140. The high pressure fluid supply system 140 can be coupled to the recirculation system 120, but this is not required. In alternate embodiments, high pressure fluid supply system supply system 140 can be configured differently and coupled differently. For example, the high pressure fluid supply system 140 can be coupled to the processing chamber 110. The fluid supply system 140 can include a supercritical fluid supply system. A supercritical fluid as referred to herein is a fluid that is in a supercritical state, which is that state that exists when the fluid is maintained at or above the critical pressure and at or above a critical temperature on its phase diagram, which pressure is typically also temperature dependent. In such a supercritical state, the fluid possesses certain properties, one of which is the substantial absence of a surface tension. Accordingly, a supercritical fluid supply system, as referred to herein, is one that delivers to a processing chamber a fluid that assumes a supercritical state at the pressure and temperature at which the processing chamber is being controlled. Furthermore, it is only necessary that at least at or near the critical point so that the fluid is in a substantially supercritical state at which its properties are sufficient, and exist long enough, to realize their advantages in the process being performed. Carbon dioxide, for example, is a supercritical fluid when maintained at or above a pressure of about 1070 psi at a temperature of 31 degrees C., a pressure that varies inversely with temperature. This state of the fluid in the processing chamber may be maintained by operating the chamber at 2,000 to 6,000 psi at a temperature of between 60 and 100 degrees C., for example.

The high pressure fluid supply system 140 can include a supercritical fluid supply system, which can be a carbon dioxide supply system. The high pressure fluid supply system 140 can be configured to introduce a high pressure fluid having a pressure substantially near the critical pressure for the fluid. Additionally, the high pressure fluid supply system 140 can be configured to introduce a supercritical fluid, such as carbon dioxide in a supercritical state. Examples of other supercritical fluid species useful in the broad practice of the invention include, but are not limited to, carbon dioxide (as described above), oxygen, argon, krypton, xenon, ammonia, methane, methanol, dimethyl ketone, hydrogen, and sulfur hexafluoride. The high pressure fluid supply system can, for example, comprise a carbon dioxide source (not shown) and a plurality of flow control elements (not shown) for generating a supercritical fluid. For example, the carbon dioxide source can include a CO2 feed system, and the flow control elements can include supply lines, valves, filters, pumps, and heaters. The high pressure fluid supply system 140 can comprise an inlet valve (not shown) that is configured to open and close to allow or prevent the stream of supercritical carbon dioxide from flowing into the processing chamber 110. For example, controller 150 can be used to determine fluid parameters such as pressure, temperature, process time, and flow rate.

Referring still to FIG. 1, the process chemistry supply system 130 is coupled to the recirculation system 120, but this is not required for the invention. In alternate embodiments, the process chemistry supply system 130 can be configured differently, and can be coupled to different elements in the high pressure processing system 100. The process chemistry is introduced by the process chemistry supply system 130 into the fluid introduced by the fluid supply system 140 at ratios that vary with the substrate properties, the chemistry being used and the process being performed in the chamber. Usually the ratio is roughly 1 to 5 percent by volume, which, for a chamber, recirculation system and associated plumbing having a volume of about 1 liter amounts to about 10 to 50 milliliter of additive in most cases, but the ratio may be higher or lower.

The process chemistry supply system 130 can be configured to introduce one or more of the following process compositions, but not limited to: cleaning compositions for removing contaminants, residues, hardened residues, photoresist, hardened photoresist, post-etch residue, post-ash residue, post chemical-mechanical polishing (CMP) residue, post-polishing residue, or post-implant residue, or any combination thereof; cleaning compositions for removing particulate; drying compositions for drying thin films, porous thin films, porous low dielectric constant materials, or air-gap dielectrics, or any combination thereof; film-forming compositions for preparing dielectric thin films, metal thin films, or any combination thereof; or any combination thereof. Additionally, the process chemistry supply system 130 can be configured to introduce solvents, co-solvents, surfactants, film-forming precursors, or reducing agents, or any combination thereof.

The process chemistry supply system 130 can be configured to introduce N-Methyl Pyrrolidone (NMP), diglycol amine, hydroxylamine, di-isopropyl amine, tri-isoprpyl amine, tertiary amines, catechol, ammonium fluoride, ammonium bifluoride, methylacetoacetamide, ozone, propylene glycol monoethyl ether acetate, acetylacetone, dibasic esters, ethyl lactate, CHF₃, BF₃, HF, other fluorine containing chemicals, or any mixture thereof. Other chemicals such as organic solvents may be utilized independently or in conjunction with the above chemicals to remove organic materials. The organic solvents may include, for example, an alcohol, ether, and/or glycol, such as acetone, diacetone alcohol, dimethyl sulfoxide (DMSO), ethylene glycol, methanol, ethanol, propanol, or isopropanol (IPA). For further details, see U.S. Pat. No. 6,306,564B1, filed May 27, 1998, and titled “REMOVAL OF RESIST OR RESIDUE FROM SEMICONDUCTORS USING SUPERCRITICAL CARBON DIOXIDE”, and U.S. Pat. No. 6,509,141B2, filed Sep. 3, 1999, and titled “REMOVAL OF PHOTORESIST AND PHOTORESIST RESIDUE FROM SEMICONDUCTORS USING SUPERCRITICAL CARBON DIOXIDE PROCESS,” both incorporated by reference herein.

Additionally, the process chemistry supply system 130 can comprise a cleaning chemistry assembly (not shown) for providing cleaning chemistry for generating supercritical cleaning solutions within the processing chamber. The cleaning chemistry can include peroxides and a fluoride source. For example, the peroxides can include hydrogen peroxide, benzoyl peroxide, or any other suitable peroxide, and the fluoride sources can include fluoride salts (such as ammonium fluoride salts), hydrogen fluoride, fluoride adducts (such as organo-ammonium fluoride adducts), and combinations thereof. Further details of fluoride sources and methods of generating supercritical processing solutions with fluoride sources are described in U.S. patent application Ser. No. 10/442,557, filed May 20, 2003, and titled “TETRA-ORGANIC AMMONIUM FLUORIDE AND HF IN SUPERCRITICAL FLUID FOR PHOTORESIST AND RESIDUE REMOVAL”, and U.S. patent application Ser. No. 10/321,341, filed Dec. 16, 2002, and titled “FLUORIDE IN SUPERCRITICAL FLUID FOR PHOTORESIST POLYMER AND RESIDUE REMOVAL,” both incorporated by reference herein.

Furthermore, the process chemistry supply system 130 can be configured to introduce chelating agents, complexing agents and other oxidants, organic and inorganic acids that can be introduced into the supercritical fluid solution with one or more carrier solvents, such as N,N-dimethylacetamide (DMAc), gamma-butyrolactone (BLO), dimethyl sulfoxide (DMSO), ethylene carbonate (EC), N-methylpyrrolidone (NMP), dimethylpiperidone, propylene carbonate, and alcohols (such a methanol, ethanol and 2-propanol).

Moreover, the process chemistry supply system 130 can comprise a rinsing chemistry assembly (not shown) for providing rinsing chemistry for generating supercritical rinsing solutions within the processing chamber. The rinsing chemistry can include one or more organic solvents including, but not limited to, alcohols and ketone. In one embodiment, the rinsing chemistry can comprise sulfolane, also known as thiocyclopenatne-1,1-dioxide, (Cyclo) tetramethylene sulphone and 2,3,4,5-tetrahydrothiophene-1,1-dioxide, which can be purchased from a number of venders, such as Degussa Stanlow Limited, Lake Court, Hursley Winchester SO21 2LD UK.

Moreover, the process chemistry supply system 130 can be configured to introduce treating chemistry for curing, cleaning, healing, or sealing, or any combination, low dielectric constant films (porous or non-porous). The chemistry can include hexamethyldisilazane (HMDS), chlorotrimethylsilane (TMCS), or trichloromethylsilane (TCMS). For further details, see U.S. patent application Ser. No. 10/682,196, filed Oct. 10, 2003, and titled “METHOD AND SYSTEM FOR TREATING A DIELECTRIC FILM,” and U.S. patent application Ser. No. 10/379,984, filed Mar. 4, 2003, and titled “METHOD OF PASSIVATING LOW DIELECTRIC MATERIALS IN WAFER PROCESSING,” both incorporated by reference herein.

The processing chamber 110 can be configured to process substrate 105 by exposing the substrate 105 to high pressure fluid from the high pressure fluid supply system 140, or process chemistry from the process chemistry supply system 130, or a combination thereof in a processing space 112. Additionally, processing chamber 110 can include an upper chamber assembly 114, and a lower chamber assembly 115.

The upper chamber assembly 112 can comprise a heater (not shown) for heating the processing chamber 110, the substrate 105, or the processing fluid, or a combination of two or more thereof. Alternately, a heater is not required. Additionally, the upper chamber assembly can include flow components for flowing a processing fluid through the processing chamber 110. In one example, a circular flow pattern can be established, and in another example, a substantially linear flow pattern can be established. Alternately, the flow components for flowing the fluid can be configured differently to affect a different flow pattern.

The lower chamber assembly 115 can include a platen 116 configured to support substrate 105 and a drive mechanism 118 for translating the platen 116 in order to load and unload substrate 105, and seal lower chamber assembly 115 with upper chamber assembly 114. The platen 116 can also be configured to heat or cool the substrate 105 before, during, and/or after processing the substrate 105. Additionally, the lower assembly 115 can include a lift pin assembly for displacing the substrate 105 from the upper surface of the platen 116 during substrate loading and unloading.

A transfer system (not shown) can be used to move a substrate into and out of the processing chamber 110 through a slot (not shown). In one example, the slot can be opened and closed by moving the platen, and in another example, the slot can be controlled using a gate valve.

The substrate can include semiconductor material, metallic material, dielectric material, ceramic material, or polymer material, or a combination of two or more thereof. The semiconductor material can include Si, Ge, Si/Ge, or GaAs. The metallic material can include Cu, Al, Ni, Pb, Ti, and Ta. The dielectric material can include silica, silicon dioxide, quartz, aluminum oxide, sapphire, low dielectric constant materials, Teflon, and polyimide. The ceramic material can include aluminum oxide, silicon carbide, etc.

The processing system 100 can also comprise a pressure control system (not shown). The pressure control system can be coupled to the processing chamber 110, but this is not required. In alternate embodiments, pressure control system can be configured differently and coupled differently. The pressure control system can include one or more pressure valves (not shown) for exhausting the processing chamber 110 and/or for regulating the pressure within the processing chamber 110. Alternately, the pressure control system can also include one or more pumps (not shown). For example, one pump may be used to increase the pressure within the processing chamber, and another pump may be used to evacuate the processing chamber 110. In another embodiment, the pressure control system can comprise seals for sealing the processing chamber. In addition, the pressure control system can comprise an elevator for raising and lowering the substrate and/or the platen.

Furthermore, the processing system 100 can comprise an exhaust control system. The exhaust control system can be coupled to the processing chamber 110, but this is not required. In alternate embodiments, exhaust control system can be configured differently and coupled differently. The exhaust control system can include an exhaust gas collection vessel (not shown) and can be used to remove contaminants from the processing fluid. Alternately, the exhaust control system can be used to recycle the processing fluid.

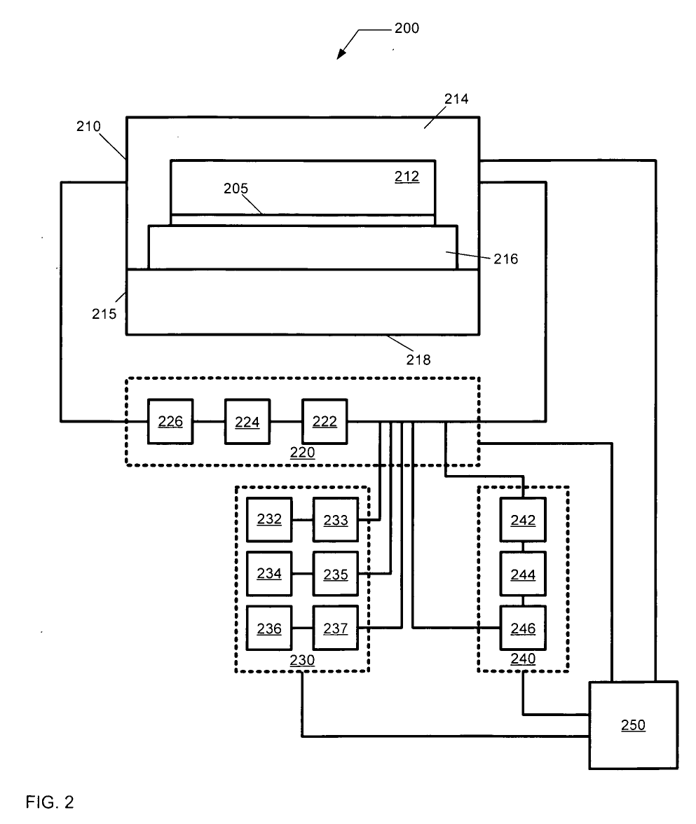

Referring now to FIG. 2, a high pressure processing system 200 is presented according to another embodiment. In the illustrated embodiment, high pressure processing system 200 comprises a processing chamber 210, a recirculation system 220, a process chemistry supply system 230, a high pressure fluid supply system 240, and a controller 250, all of which are configured to process substrate 205. The controller 250 can be coupled to the processing chamber 210, the recirculation system 220, the process chemistry supply system 230, and the high pressure fluid supply system 240. Alternately, controller 250 can be coupled to a one or more additional controllers/computers (not shown), and controller 250 can obtain setup and/or configuration information from an additional controller/computer.

As shown in FIG. 2, the recirculation system 220 can include a recirculation fluid heater 222, a pump 224, and a filter 226. Additionally, the process chemistry supply system 230 can include one or more chemistry introduction systems, each introduction system having a chemical source 232, 234, 236, and an injection system 233, 235, 237. The injection systems 233, 235, 237 can include a pump and an injection valve. Furthermore, the high pressure fluid supply system 240 can include a supercritical fluid source 242, a pumping system 244, and a supercritical fluid heater 246. Moreover, one or more injection valves, or exhaust valves may be utilized with the high pressure fluid supply system.

In yet another embodiment, the high pressure processing system can include the system described in pending U.S. patent application Ser. No. 09/912,844 (US Patent Application Publication No. 2002/0046707 A1), entitled “High pressure processing chamber for semiconductor substrates”, and filed on Jul. 24, 2001, which is incorporated herein by reference in its entirety.

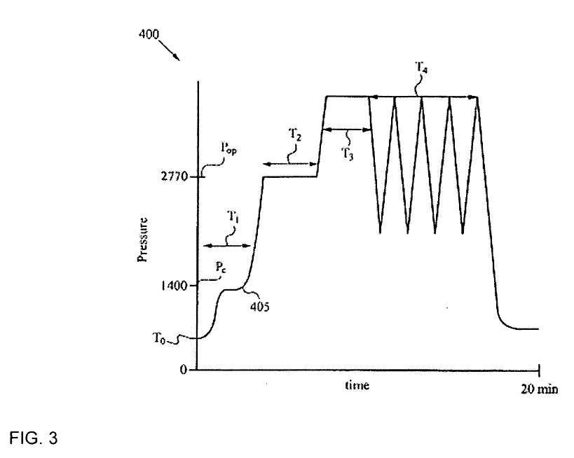

Referring now to FIG. 3, an exemplary plot 400 of pressure versus time is illustrated for a high pressure process step, such as a supercritical cleaning or treating process step. Prior to an initial time T₀, the substrate having, for example, residue thereon, is placed within the processing chamber 110 (or 210), and the processing chamber 110 is sealed. From the initial time T₀ through a first duration of time T₁, the processing chamber 110 (or 210) is pressurized. Once the processing chamber 110 (or 210) reaches the critical pressure P_{c} for the supercritical fluid (such as 1,070 psi for carbon dioxide), then a processing chemistry including a treating compound is injected into the processing chamber 110 (or 210), for instance, through the recirculation loop 120 (or 220). Several injections of process chemistries can be performed over the duration of time T₁ to generate a supercritical processing solution with the desired concentrations of chemicals. Preferably, the injection(s) of the process chemistries begin upon reaching about 1100-1200 psi, as indicated by the inflection point 405. Alternatively, the processing chemistry is injected into the processing chamber 110 (or 210) around the second time T₂, or after the second time T₂.

After processing chamber 110 (or 210) reaches an operating pressure Pₒₚ at the second time T₂ which is preferably about 3,000 psi (but can be any value so long as the operating pressure is sufficient to maintain supercritical conditions), the supercritical processing solution is circulated over and/or around the substrate, and through the processing chamber 110 (or 210) using the recirculation system 120 (or 220). Then the pressure within the processing chamber 110 (or 210) increases and, over the next duration of time, the supercritical processing solution continues to be circulated over, and/or around the substrate, and through the processing chamber 110 (or 220) using the recirculation system 120 (or 220), and/or the concentration of the supercritical processing solution within the processing chamber is adjusted by a push-through process, as described below.

Still referring to FIG. 3, in a push-through process, over the duration of time T₃, a fresh stock of supercritical fluid, such as carbon dioxide, is introduced into the processing chamber 110 (or 210), while the supercritical processing solution along with process residue suspended or dissolved therein is simultaneously displaced from the processing chamber 110 (or 210). After the push-through step is complete, then over a duration of time T₄, the processing chamber 110 (or 210) is cycled through a plurality of decompression and compression cycles. Preferably, this is accomplished by venting the processing chamber 110 (or 210) below the operating pressure Pₒₚ to about 1,100-1,200 psi in a first exhaust and then raising the pressure within the processing chamber 110 (or 210) from 1,100-1,200 psi to the operating pressure Pₒₚ, or above with a first pressure recharge. Afterwards, the decompression and compression cycles are complete, and the processing chamber is completely vented or exhausted to atmospheric pressure. For substrate processing, a next substrate processing step begins, or the substrate is removed form the processing chamber and moved to a second process apparatus or module to continue processing.

The plot 400 is provided for exemplary purposes only. It will be understood by those skilled in the art that a high pressure processing step, such as a supercritical processing step, can have any number of different time/pressures or temperature profiles without departing from the scope of the present invention. Further any number of cleaning and rinsing processing sequences with each step having any number of compression and decompression cycles are contemplated. Also, as stated previously, concentrations of various chemicals and species within a supercritical processing solution can be readily tailored for the application at hand and altered at any time within a supercritical processing step.

A consequence of high pressure processing, as well as pressure cycling, whereby variations of pressure are incurred, the processing system can be susceptible to the formation of particulate which can disperse upon a surface of the substrate. Furthermore, the nature of some chemistries can lead to the corrosion of internal members in the high pressure processing system, again leading to the formation of particulate which can disperse on the surface of the substrate. Particle contamination of a substrate surface can lead to loss in device yield.

According to an embodiment, one or more surfaces on internal members of the high pressure processing system are protected with a coating. Internal members of the high pressure processing system have at least one surface that comes into contact with processing solution including high pressure fluid, or process chemistry, or both before, during, or after processing of a substrate. The internal members can include the processing chamber or a portion of the processing chamber, the recirculation system or a portion of the recirculation system, the process chemistry supply system or a portion of the process chemistry supply system, the high pressure fluid supply system or a portion of the high pressure fluid supply system, the upper chamber assembly or a portion of the upper chamber assembly, the lower chamber assembly or a portion of the lower chamber assembly, the platen or a portion of the platen, a valve or portion of a valve, a filter or a portion of a filter, a pump or a portion of a pump, a tube or a portion of a tube, plumbing, or a portion of the plumbing associated with the high pressure processing system, a supply tank or a portion of the supply tank, an exhaust tank or a portion of the exhaust tank, or any combination thereof. The internal member can include any member of the high pressure processing system having a surface in contact with the high pressure fluid, the process chemistry, or both before, during, or after processing of the substrate.

Internal members of the high pressure processing system can be fabricated from stainless steel, or various steel alloys such as steel alloys having high nickel and chromium content, Hastelloy steel, Nitronic 50, Nitronic 60, or 300 series stainless steel.

The coating can have a composition including plastics, polymers, fluoroplastics, fluoropolymers, or chloropolymers. The coating can include Teflon, polyimide, and mixtures thereof. For example, the coating can include HL1284 black Teflon® (PTFE) commercially available from Alpha Tech Coatings, Inc. (Maricopa, Ariz., 85239), which can be applied using spray (dispersion) coating followed by a thermal cure (bake cycle). Additionally, the coating can include fluorinated ethylene propylene (FEP) commercially available from Sermatech International (Limerick, Pa.), which can be applied using spray (dispersion) coating followed by a thermal cure. Additionally, for example, the coating can include Vespel® SCP-5000 polyimide commercially available from DuPont. Additionally, for example, the coating can include Parylene commercially from Parylene Coating Services, Inc. (Katy, Tex.), which can be applied using vapor deposition techniques. Additionally, for example, the coating can include high density polyethylene. Additionally, for example, the coating can include Microlon® commercially available from Kyowa Developing and Materials, Inc.

Alternatively, the coating can include ceramics, glasses, oxides, nitrides, carbides, fluorides, or silicon-containing compositions. The coating can include aluminum oxide, sapphire, silicon, silicon oxide, silicon nitride, silicon carbide, boron nitride, boron carbide, or titanium nitride. For example, the coating can include UltraC Diamond, UHP silicon, silicon carbide, or silicon nitride commercially available from Surmet Corporation (Santa Clara, Calif.), which can be deposited using vapor deposition techniques. Additionally, for example, the coating can include PSXCH sapphire commercially available from Popper & Sons (New Hyde Park, N.Y.), which can be applied using chemical vapor deposition techniques.

Alternatively, the coating can include Al₂O₃, or Y₂O₃, or a mixture thereof. The coating can include a III-column element (column III of periodic table), or a Lanthanon element, or both. The III-column element can comprise one or more of Yttrium, Scandium, and Lanthanum. The Lanthanon element can comprise one or more of Cerium, Dysprosium, and Europium. Additionally, the coating includes one or more of Yttria (Y₂O₃), Sc₂O₃, Sc₂F₃, YF₃, La₂O₃, CeO₂, Eu₂O₃, and DyO₃.

The coating can be formed on surfaces using a number of techniques including, but not limited to: thin film deposition techniques, such as ionic plasma deposition (IPD), physical vapor deposition (PVD), sputtering, thermal deposition, or chemical vapor deposition (CVD); dip-coating; immersion coating; spray coating; thermal spray coating; anodization; plasma electrolytic oxidation; or implantation. Additionally, once coatings are applied to one or more surfaces on internal members, the coatings may be cured, or baked.

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. An internal member of a system for processing a substrate with a supercritical fluid, the member comprising:
a structural element configured to be coupled to a high pressure processing system;
a coating coupled to one or more surfaces of said structural element, and configured to reduce contamination released from the element into said supercritical fluid in said high pressure processing system.

2. The internal member of claim 1, wherein said coating on said one or more surfaces contacts a supercritical fluid, a process chemistry, or both.

3. The internal member of claim 1, wherein said coating comprises a plastic, a thermoplastic, fluoroplastic, a polymer, a fluoropolymer, or a chloropolymer or any combination thereof.

4. The internal member of claim 1, wherein said coating comprises Teflon (PTFE), a polyimide, a fluorinated ethylene propylene, a polyethylene, or Parylene, or any combination thereof.

5. The internal member of claim 1, wherein said coating comprises a ceramic, a glass, an oxide, a nitride, a carbide, a fluoride, or a silicon-containing material, or any combination thereof.

6. The internal member of claim 1, wherein said coating comprises silicon, silicon nitride, silicon oxide, silicon carbide, boron carbide, boron nitride, aluminum oxide, sapphire, or titanium nitride, or any combination thereof.

7. The internal member of claim 1, wherein said coating comprises a column III element, and a Lanthanon element.

8. The internal member of claim 1, wherein said coating is applied to said structural element using ionic plasma deposition (IPD), physical vapor deposition (PVD), sputtering, thermal deposition, chemical vapor deposition (CVD), dip-coating, immersion coating, spray coating, thermal spray coating, dispersion coating, anodization, plasma electrolytic oxidation, or implantation, or any combination thereof.

9. The internal member of claim 8, wherein said coating is cured following application of said coating to said structural element.

10. The internal member of claim 1, wherein said high pressure processing system includes a processing system configured to use a high pressure fluid substantially near the critical state of the fluid, a critical fluid, or supercritical fluid, or any combination thereof.

11. A high pressure processing system for treating a substrate with a supercritical fluid, the system comprising:
a processing chamber configured to treat said substrate with a high pressure fluid, introduced therein, having substantially supercritical fluid properties;
a high pressure fluid supply system coupled to said processing chamber, and configured to introduce a high pressure fluid to said processing chamber;
a process chemistry supply system coupled to said processing chamber, and configured to introduce a process chemistry to said processing chamber;
a fluid flow system coupled to said processing chamber, and configured to circulate said high pressure fluid and said process chemistry through said processing chamber over said substrate; and
a coating coupled to one or more surfaces of said processing chamber, said high pressure fluid supply system, said process chemistry supply system, or said recirculation system, or any combination thereof.

12. The high pressure processing system of claim 11, wherein said coating on said one or more surfaces contacts a supercritical fluid, a process chemistry, or both.

13. The high pressure processing system of claim 11, wherein said coating comprises a plastic, a thermoplastic, fluoroplastic, a polymer, a fluoropolymer, or a chloropolymer or any combination thereof.

14. The high pressure processing system of claim 11, wherein said coating comprises Teflon (PTFE), a polyimide, a fluorinated ethylene propylene, a polyethylene, or Parylene, or any combination thereof.

15. The high pressure processing system of claim 1, wherein said coating comprises a ceramic, a glass, an oxide, a nitride, a carbide, a fluoride, or a silicon-containing material, or any combination thereof.

16. The high pressure processing system of claim 1, wherein said coating comprises silicon, silicon nitride, silicon oxide, silicon carbide, boron carbide, boron nitride, aluminum oxide, sapphire, or titanium nitride, or any combination thereof.

17. The high pressure processing system of claim 1, wherein said coating comprises a column III element, and a Lanthanon element.

18. The high pressure processing system of claim 1, wherein said coating is applied to said internal member using ionic plasma deposition (IPD), physical vapor deposition (PVD), sputtering, thermal deposition, chemical vapor deposition (CVD), dip-coating, immersion coating, spray coating, thermal spray coating, dispersion coating, anodization, plasma electrolytic oxidation, or implantation, or any combination thereof.

19. The high pressure processing system of claim 8, wherein said coating is cured following application.

20. A high pressure processing system for treating a substrate comprising:
a processing chamber configured to treat said substrate with a high pressure fluid, introduced therein, having substantially supercritical fluid properties;
a carbon dioxide supply system coupled to said processing chamber, and configured to introduce carbon dioxide to said processing chamber;
a process chemistry supply system coupled to said processing chamber, and configured to introduce a process chemistry to said processing chamber;
a fluid flow system coupled to said high pressure processing system, and configured to flow supercritical carbon dioxide and said process chemistry through said processing chamber over said substrate; and
a coating coupled to one or more surfaces of said processing chamber, said carbon dioxide supply system, said process chemistry supply system, or said fluid flow system, or any combination thereof.

21. The high pressure processing system of claim 20, wherein said carbon dioxide is introduced in a liquid state, a gaseous state, or a supercritical state.

22. A method for treating a substrate in a supercritical processing system comprising:
disposing an internal member in said supercritical processing system having a coating on one or more surfaces configured to reduce contamination in said supercritical processing system, wherein said coating protects said internal member from process chemistry, supercritical fluid, or both in said supercritical processing system;
disposing a substrate in said supercritical processing system;
exposing said substrate to said supercritical fluid; and
exposing said substrate to said processing chemistry.
